(19) United States
(12) Patent Application Publication
(10) Pub. No.: US 2006/0193542 A1
(43) Pub. Date: Aug. 31, 2006

(54) Structural bearing using fully housed partially confined elastomer

(76) Inventors: Paul Fred Bradford, Willimsville, NY (US); Ronald James Watson, E. Amherst, NY (US)

Correspondence Address: PAUL BRADFORD, 78 JOHN GLENN DRIVE, AMHERST, NY, 14228, US

(21) Appl. No.: 11/066,218

(22) Filed: Feb. 28, 2005

(51) Int. Cl. F16C 41/00; F16C 27/06

(52) U.S. Cl. 384/36

(57) ABSTRACT

A high load structural bearing primarily comprising a high strength elastomer and a housing with top closure plate. The housing is composed of sidewalls and is attached to a bottom base plate. The elastomeric pad has its top edge chamfered to produce a void that allows the pad to expand while being compressed without being squeezed into the gap between the sidewalls and the closure plate. The high load elastomer and surrounding housing are designed such that the elastomer is loaded in two phases in a controlled, predictable fashion. In the first phase the elastomer expands unrestrained on its lateral sides until it makes contact with the sidewalls. In the second phase the elastomer vertical compression increases and subsequently tensile stresses existing at the end of the first phase are mitigated to a predetermined level via lateral confinement from the housing sidewalls.

### CROSS-REFERENCE TO RELATED APPLICATIONS

This application claims the benefit of PPA Ser. No. 60/546,210, filed Feb. 23, 2004 by the present inventors.

### FEDERALLY SPONSORED RESEARCH

Not Applicable

### SEQUENCE LISTING OR PROGRAM

Not Applicable

### BACKGROUND OF THE INVENTION

1. Field of Invention

This invention relates to structural high load bearings, specifically bearings designed with elastomeric material used to transfer vertical loads and accommodate structural rotation.

### BACKGROUND OF THE INVENTION

This invention relates to bearings used to support large horizontal and vertical structural loads, i.e. high load bearings. Bearings typically contain some mechanism to allow for rotation of the structure above. Often a pliable material such as elastomer is employed to perform this function. All high load bearings employ some mechanism to prevent the elastomeric pad material from becoming overstressed. This invention employs a new method to prevent material overstressing, in turn allowing it to perform in a functionally superior manner to other bearing types.

This type of bearing, relies on both the structural strength of the material itself, and additional support from a surrounding wall to place the material in such a state of stress and geometric configuration that allows the bearing to increase its capacity for load, deflection, material strain, and rotation over existing bearing types.

### BACKGROUND OF THE INVENTION

2. Prior Art

The inherent strength of an elastomeric pad can be loosely defined as the compression at which damage occurs for a pad that is squeezed between frictionless plates. The elastomeric elements used in high load bearings would be excessively large if only their inherent strength were used, hence methods have been devised to maintain a stress state within the working limits of the material. Three common methods of elastomeric confinement are detailed below. All three have limitations in the load and rotation capacities, as well as vertical compliance. Because of its novel partial confinement, the bearing of this invention extends the limitations currently experienced on these three other approaches.

Pot, or floating, bearings (Klaw et al U.S. Pat. No. 4,928,339) are an example of an elastomer being used in a situation where the loads are much greater than the elastomer's inherent material strength. If equal, or nearly equal compressive stress is applied to a cube of the material in all directions, its von Mises stresses, e.g. the stresses tending to destroy the material, are small. This is because the stresses in the materials 3 principle stress directions are nearly equal, and the material is said to be in a hydrostatic stress state. Any one of the stresses alone would be enough to damage the elastomer, but when large stresses are applied nearly equally in all directions, distortion, and hence, damage, is prevented. This hydrostatic stress state is produced by configuring the elastomeric disc to fit tightly within the confines of the pot. A circumferential sealing ring is used around the top of the discs periphery in an attempt to maintain the hydrostatic stress state. Many different seal types have been proposed, some rigid (Andra et al U.S. Pat. No. 5,466,068), and some flexible (Koester et al U.S. Pat. No. 3,782,789), some of them fairly elaborate (Andra et al U.S. Pat. No. 3,728,752). But the end function is the same, to tightly seal the load bearing elastomeric pad such that a hydrostatic stress state can be produced upon loading. This is a fully confined elastomer, it can accommodate high vertical loads, and is very stiff in the vertical direction. Relative to other high load bearing types, it has questionable rotational fatigue performance, with many field failures occurring over the years. With cyclic rotation the sealing ring wears over time and the elastomer is no longer able to maintain its hydrostatic stress state, eventually leaking out the sides of the elastomer chamber. The bearing can accommodate low cycle rotation well, with service load rotations limited to about 0.03 radians. Thus for moderate to high fatigue rotation demands and/or cases were vertical flexibility is a desirable trait, this bearing has significant limitations.

Reinforced elastomeric bearing pads utilize a material (natural rubber or neoprene) stressed to a level that is higher than its inherent material strength, but on the order of half that of pot bearings. The stresses are large enough to cause the material to expand outward excessively and fail without some form of restraint, hence various mechanisms have been devised to restrain elastomeric expansion, including bonding the upper and lower surfaces can to steel, and embedding rings in the elastomer hoops (Hein et al U.S. Pat. No. 3,938,852). The effect is to limit vertical deflection and provide a hydrostatic stress state around the central region of the bearing. In order to limit vertical deflection and shear stresses in the rubber pad, only thin layers of rubber can be used. Typical shape factors, the ratio of the loaded to bulge areas, are between 10 and 20. A thin layer of elastomer cannot accommodate structural rotation well, hence many of these layers are stacked to form a laminate of rubber and steel. Characteristics include high vertical stiffness, maximum allowable rotation on the order of 0.01 radians, and large plan area, max vertical loads of approximately 1600 kN. Thus for moderate to high service rotation demands, high loads, and/or cases were vertical flexibility is a desirable trait, this bearing has significant limitations.

Reinforced elastomeric bearings can be designed to display enough lateral flexibility to be effective in serving as a high frequency vibration absorber, e.g. for frequencies above 5.0 Hz (Coble et al U.S. Pat. No. 2,911,207). However for seismic protection, where the bearing has to be flexible enough to shift the natural frequency of the structure to less than 1.0 Hz, bearings must be on the order of 25 times more flexible. The bearing is inherently much more flexible in the lateral direction than the vertical direction, and it is only possible to produce this level of flexibility in the horizontal direction (Fyfe U.S. Pat. No. 5,014,474, Robinson U.S. Pat. No. 4,117,637), without the bearings becoming too tall and unstable.

Disc bearings (Fyfe et al, U.S. Pat. No. 4,187,573) are an example of an application where the material is being compressed to a level in scale with the material's inherent strength. Like the steel reinforced elastomeric bearing, it too is restrained on both of its top and bottom surfaces to restrain lateral expansion. However, it need not be thinly layered, typical shape factors are around 2.0. The elastomeric element, polyurethane, is on the order of 10 times stiffer than typical black rubbers (neoprene or natural rubber) used in elastomeric pads and pot bearings. The inherent material strength allows it to function without having to be placed in a hydrostatic stress state (such as in the pot bearing), or be configured to have high shape factor layers with steel bonded surfaces (as in a steel reinforced elastomeric bearing). A low shape factor disc geometry with friction bonded top and bottom surfaces has proven to work well. The bearing can accommodate both high fatigue and service rotations, as well as high horizontal and vertical loads. It is of moderate vertical stiffness. However, for situations were very high rotations (rotations above 0.03 radians), very high horizontal loads (horizontal loads above 50% of the vertical), or soft vertical compliance the elastomeric element either cannot be designed to perform to specification, or if it can it becomes too large and uneconomical to produce.

A bearing similar to the disc bearing (Fyfe U.S. Pat. No. 5,597,240) has an inner elastomeric ring surrounding its centrally located shear pin, ostensibly to assist in bearing rotation without the added expense of machined shear pin joint, however this configuration cannot withstand high horizontal loads without material damage, and does nothing to address the high elastomeric pad stresses due to pad rotation.

Currently there exists no economical high load bearing elastomeric solution to very high rotational capacity demand (service>0.030 radians, and fatigue>0.015 radians) and/or soft vertical compliance (e.g. for seismic vibration mitigation).

### BACKGROUND OF THE INVENTION—OBJECTS AND ADVANTAGES

The bearing in this invention combines the bearing pad's inherent material strength and partial confinement of the pad to resist vertical loads and subsequently increase capabilities. With the appropriate configuration, damaging tensile stresses can be removed from the bulk of the elastomer.

This has many practical advantages. For example, the bearing can be configured to undergo very large vertical displacements before causing material duress in the pad. If the top and bottom surfaces have low coefficients of friction, the material is free to expand until it hits the sidewalls, giving it a stiffening spring characteristic, as well as allowing for large compression deflections. Housing walls can also be used to prevent excessive material creep. Lower tensile stresses and use of thicker material means very large rotations can be achieved without overstressing the material or causing excessive bearing eccentricity.

Accordingly, besides the objects and advantages of the described elsewhere in this patent, several objects and advantages of the present invention are:
(a) To provide a bearing that does not rely upon a seal for the elastomeric load bearing element in order to maintain vertical loads.
(b) To provide a bearing that utilizes a large diameter wall to resist large horizontal loads but does not require a seal for the elastomer.
(c) To provide a bearing that is robust against fatigue rotation, i.e. it is not designed such that a small amount of component wear can lead to bearing failure.
(d) To provide a bearing that can produce large vertical deflections without damage to the elastomer.
(e) To provide an elastomeric based bearing that can accommodate larger service rotations than currently possible.
(f) To provide an elastomeric based bearing superior in rotational fatigue resistance to all other bearing types.
(g) To produce a bearing that can deflect vertically enough to dampen vertical shocks and oscillations, a bearing that is on the order of ten times as flexible in the vertical direction as current structural bearings.
(h) To produce a bearing with an elastomeric stress state such that its tensile stresses in the principle stress directions for the bulk of the elastomer have been made insignificant.
(i) To produce a bearing pad of which its stress state can be highly controlled by engineering pad contours and housing sidewall features.
(j) To provide a bearing that can act as a nonlinear spring if so desired, with a lower stiffness at lighter loads and higher stiffnesses at higher loads.
(k) To provide a bearing that can act as a nonlinear spring if so desired, with a higher stiffness at lighter loads and lower stiffness at moderate loads, and higher stiffnesses again at higher loads.

Further objects and advantages are to provide a bearing that can accomplish all of the above and yet still be inexpensive to manufacture, which can be pre-compressed to limit deflection if need be, which can increase bearing robustness, reliability, and vertical load margin. Still further objects and advantages will become apparent from a consideration of the ensuing description and drawings.

### SUMMARY

In accordance with the present invention a high load structural bearing comprising a high strength elastomer located inside an unsealed housing with a top closure plate and a bottom base plate.

### DRAWINGS—FIGURES

FIG. 1—Shows the preferred embodiment.

FIG. 2—Shows components of the preferred embodiment.

FIG. 3—Shows an additional embodiment

FIG. 4—Shows components of an additional embodiment

FIG. 5—Shows an alternative embodiment with pretensioned bolts

FIG. 6—Shows an alternative embodiment with a preload pad

FIGS. 7A and 7B—Shows unloaded and loaded elevations of the preferred embodiment

FIG. 8 and FIG. 9—Shows force versus deflection plots of alternative embodiments

### DRAWINGS—REFERENCE NUMERALS

1 base plate
2 housing plate
3 closure plate
4 pad
5 housing sidewall
6 pad shoulder
7 pad profile
8 pad top surface
9 housing side plate
10 housing fore plate
11 uplift pin
12 cap plate
13 pad void
14 pretension bolt
15 bolt washer
16 preload pad

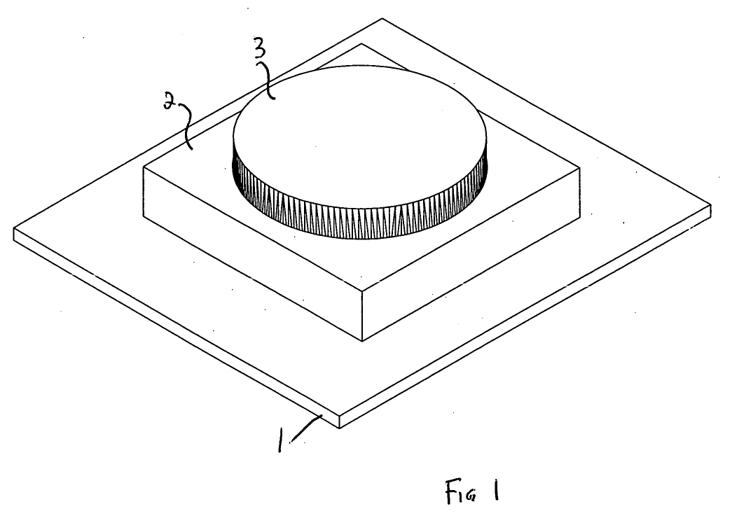

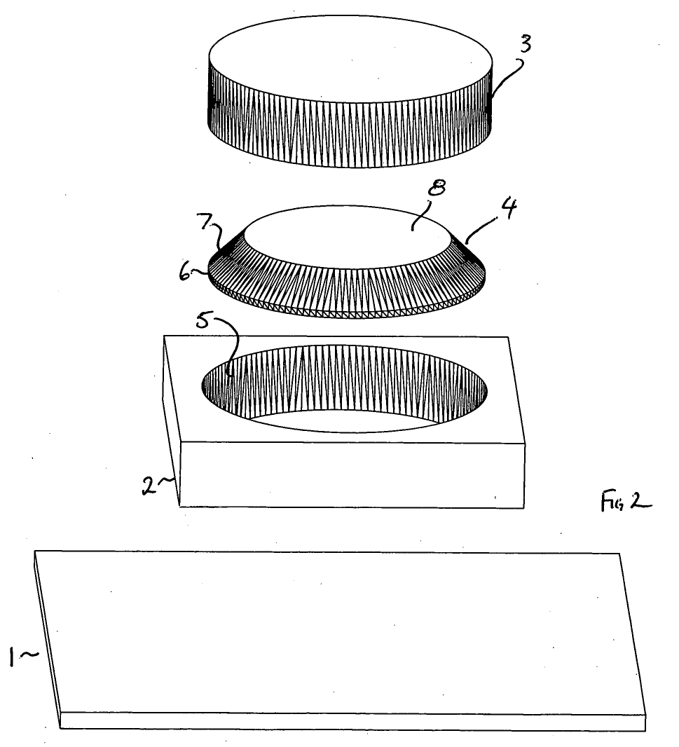

### DETAILED DESCRIPTION—FIG 1, FIG. 2, FIG. 7A, FIG. 7B

A preferred embodiment of the present invention is illustrated in FIG. 1 and FIG. 2. The bearing has base plate 1 that the housing plate 2 is rigidly attached to. The bottom of the base plate 1 is attached to the structure, typically the substructure through a connection means not shown. Housing plate 2 and its interior wall, housing sidewall 5, provide means of confinement of the pad 4. Pad 4 is composed of a high strength polyurethane in the preferred embodiment. Pad 4 is detailed with a side profile to assist in the necessary pad expansion and semi-confinement functions. Various types of side profiling are possible, shown here as pad profile 7 and pad shoulder 6. Closure plate 3 is means to apply the vertical load to the pad 4. Pad top surface 8 may be contoured or flat, depending upon the desired pad stress distribution and/or rotation requirements. Pad void 13 exists between pad 4, housing sidewall 5, and closure plate 3.

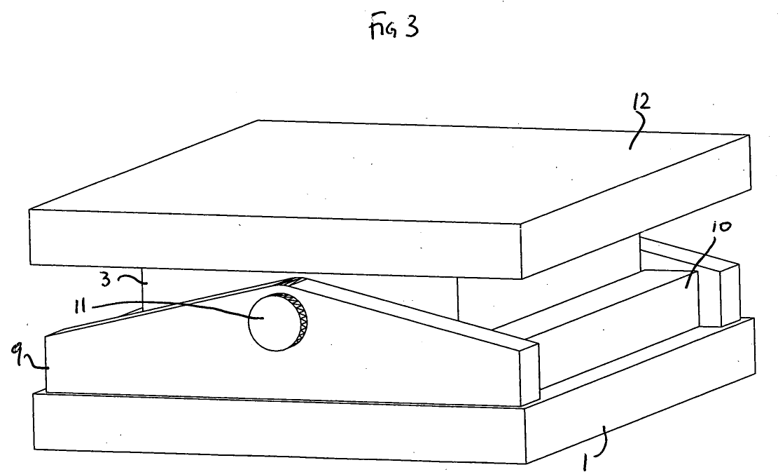

FIG. 3, FIG. 4—Additional Embodiments

An additional embodiment, a rectangular derivative of the preferred embodiment of the present invention is illustrated in FIG. 3 and FIG. 4. The bearing has a base plate i that the housing fore plate 10 and housing side plate 11 are rigidly attached to. The bottom of the base plate 9 is attached to the structure, typically the substructure through a connection means not shown. The housing side plate 9 and housing fore plate 10 provide means of confinement of the pad 4. Pad 4 is detailed with a side profile to assist in the necessary pad 4 expansion and semi-confinement functions. Various types of side profiling are possible, a chamfer in the direction of rotation is shown here as pad profile 7. Closure plate 3 is used to apply the vertical load to the pad 4. Pad surface 8 may be profiled or flat, depending upon the pad stress distribution and/or rotation requirements; a cylindrical surface in the direction of rotation is shown here. Cap plate 12 is used to connect the bearing with the superstructure.

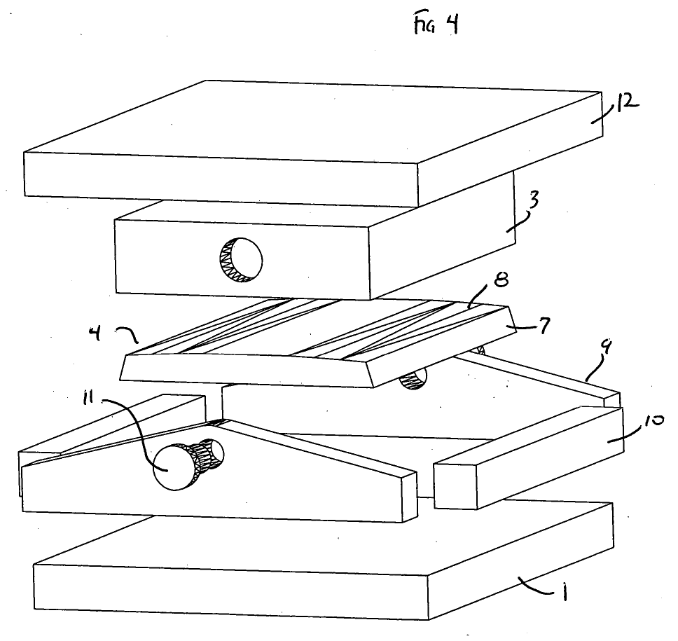

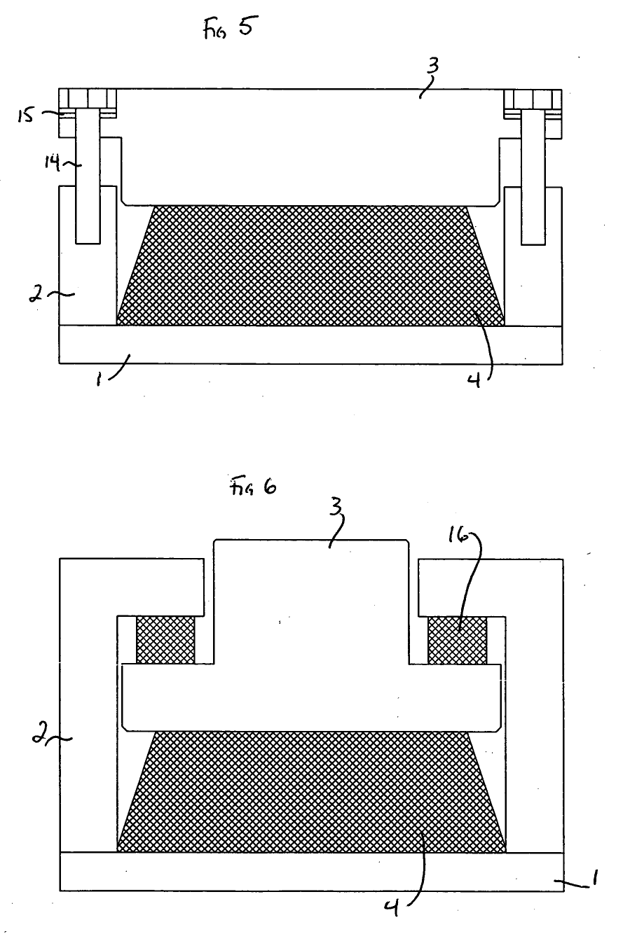

FIG. 5, FIG. 6—Alternative Embodiments

There are various possibilities with regard to the geometry of the pad in relation to the housing that allow for additional functionalities. FIG. 5 shows a variation of the bearing of this invention, one utilizing a tall pad 4 that is precompressed with pretension bolts 14. FIG. 6 shows the bearing of this invention precompressed with an additional preload pad 16, and extending portion of housing plate 2. It is not necessary to shape housing plate 2 as shown in FIG. 6, only that one end of the preload pad 16 is “grounded” to the substructure. For example if so desired a separate rigid member extending from the base plate 1 could be used. It is also possible to use metallic springs (coil, leaf, Belleville, etc.) instead of an elastomeric for preload pad 16 as means to precompress the bearing pad 4.

Operation—FIG. 7A-7B

FIG. 7A shows an elevation of a bearing prior to being loaded. A vertical load is transmitted from the superstructure through the following load path; closure plate 3, pad 4, base plate 1, to the substructure. At small loads pad 4 does not make contact with the housing sidewall 5. During this initial compression process, pad 4 is expanding laterally while its thickness is reduced due to vertical compression. At load state 1, pad 4 has expanded until pad shoulder 5 reaches housing sidewall 3. At this point, material near pad 4 edge sees compressive stresses in the vertical direction and tensile stresses in its radial direction. The stress state of material near the edge of pad 4 can be described generally by;
τ1_{zz}=−ε_{c1}·E_{c1} (1)
τ1ᵣᵣ=A (2)
where τ1_{zz} and τ1ᵣᵣ are the vertical and radial stresses at the end of the first phase. ε_{c1} and E_{c1} are the phase 1 compressive strain and compressive modulus respectively, while A is the stress magnitude. Another vertical load is applied until load state 2 is reached (FIG. 7B), the aforementioned region in pad 4 sees a compressive stress due to this load because of the side wall confinement.
τ2_{zz}=−ε_{c2}·E_{c2} (3)
τ2ᵣᵣ=−B (4)
where τ2_{zz} and τ2ᵣᵣ are the vertical and radial stresses at the end of the second phase. ε_{c1} and E_{c2} are the phase 2 compressive strain and compressive modulus respectively, while B is the stress magnitude.

Adding the two effects together;
τ_{zz}=τ1_{zz}+τ2_{zz}=−(ε_{c1}·E_{c1}+ε_{c2}·E_{c2}) (5)
τᵣᵣ=τ1ᵣᵣ+τ2ᵣᵣ=A−B (6)
where τᵣᵣ and τ_{zz} are the radial and vertical strains respectively. It can be seen that by loading the pad such that B≧A it is possible to remove the tensile stress from this area. Elastomers in general can withstand very large compressive stresses—it's typically the tensile stresses that damage elastomer.

Another perspective of the same effect can be gained from the equations of classical linear elasticity. Radial stress is defined (for a circular pad configuration) as;
τᵣᵣ=2μ·εᵣᵣ+λe (7)
where εᵣᵣ is the radial strain, μ and λ Lame constants, and e the volume dilitation, defined by;
e=εᵣᵣ+ε_{θθ}+ε_{zz} (8)

For free expansion, the radial strain quantity, εᵣᵣ is positive, and e is very small. During phase 2, because of the lateral confinement εᵣᵣ and ε_{θθ} change little, however the vertical strain ε_{zz} becomes increasingly negative due to increased compression. The overall effect is to make e increasingly negative with compression. With enough compression, the two right hand side terms in equation (7) equal each other in magnitude but are opposite in sign. At this point the radial strain, τᵣᵣ, is zero, akin to the case of equation (6) where A=B.

With appropriate pad 7 profile, pad top surface 8, friction on base plate 1, closure plate 3, and the partial confinement action of housing sidewall 3, it is possible to create a stress state in pad 4 such that tensile stresses in the bulk of pad 4 have been removed. As can be observed in FIG. 7B, the pad top surface 8 has not reached housing sidewall 5, maintaining its void 13, and no elastomer seal is required.

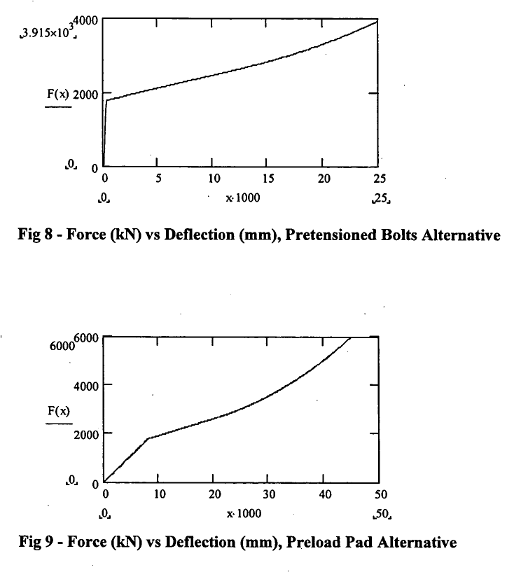

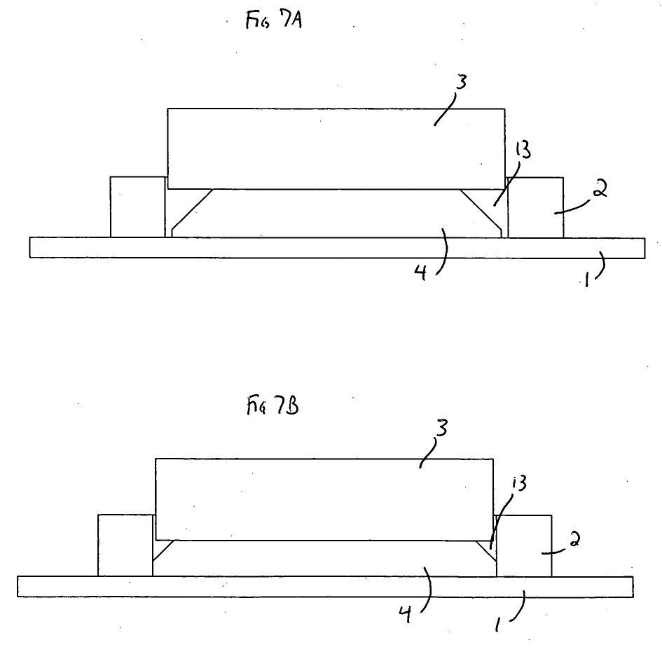

Operation of Alternative Embodiments—FIG. 5, FIG. 6, FIG. 8, FIG. 9

FIG. 5 shows a bearing that has been pre-compressed with pretension bolts 14. A vertical load is transmitted from the superstructure through the following load path; closure plate 3, pad 4, base plate 1, to the substructure. At small loads the closure plate moves downwards very little, on the order of tenths of a millimeter. At this stage the tension in the pretension bolt 14 is being relieved, the stiffness is very high, equal to the superposition of the bolt stiffnesses and the bearing pad stiffness. Once the tension in the pretension bolts 14 has been relieved, the loading continues as described in the preferred embodiment. The overall effect is to produce a nonlinear bearing spring, with a spring rate that is extremely high initially—essentially infinite relative to the scale of bearing deflections, then during phase 1 the spring rate is low, and during phase 2 the spring rate is increasing. FIG. 8 shows a typical force versus deflection characteristic for this alternative embodiment.

FIG. 6 shows a bearing that has been precompressed with preload pad 16. The preload pad 16 is oriented in the same direction as pad 4, and is sandwiched between the housing plate 2 and the closure plate 3. A vertical load is transmitted from the superstructure through the following load path; closure plate 3, pad 4, base plate 1, to the substructure. At small loads closure plate 3 moves downwards at a rate of the combined stiffness of the elastomeric preload pad 16 and pad 4. The deflection during this phase is not insignificant, and may be on the order of tens of millimeters. The preload pad 16 acts only in compression, in other words it is not attached to the housing plate 2 and hence cannot act in tension. Once the precompression on the preload pad 16 has been relieved, the loading continues as described in the preferred embodiment. The overall effect is to produce a nonlinear bearing spring, with a spring rate that is high initially, then during phase 1 the spring rate is low, and during phase 2 the spring rate is increasing. FIG. 9 shows a typical force versus deflection characteristic for this alternative embodiment.

### ADVANTAGES

From the description above, a number of advantages of the bearing become evident:
(a) Partial confinement precludes the need for an elastomer seal, increasing the bearing's reliability, particularly for rotational fatigue.
(b) With partial confinement the tensile stresses can be removed from the bulk of the elastomer, producing a more robust design, better suited for live load fatigue applications.
(c) Larger service level rotations can be accommodated.
(d) By combining the concept of partial confinement and the geometry of a thick pad, bearings that are very flexible in the vertical direction can be designed. This approach is especially beneficial for cases where vibration or seismic isolation in the vertical direction is desired.
(e) The bearing can be used as a nonlinear structural spring, with a wide range of nonlinear behaviors available for design. Because with this invention it is possible to produce a bearing that is flexible in the vertical direction, it is now possible to configure the bearing to produce a stiff-then-soft spring characteristic. Heretofore the only nonlinear softening spring characteristic available for bearing applications to designers was the infinitely stiff-then-stiff characteristic.
(f) Profiling the sides and/or the top surface along with partial confinement lends a great deal of flexibility and control of the pad stress distribution. This flexibility and control can be used to design the bearing for increased capacities, increased strain capabilities, and higher reliability.
(g) The simplicity of the bearing hardware belies the complexity of the pad stress control mechanisms. Because of this hardware simplicity, the bearing is inexpensive to manufacture.

Once design rules are established and analysis efficiencies gained, the bearing should be highly competitive with current bearing types with the improvements of the added functionalities mentioned above.

### CONCLUSIONS, RAMIFICATIONS, AND SCOPE

Accordingly, the reader will see that the bearing of this invention can be manufactured easily, lends itself to greater design flexibility, adds to bearing reliability, and can accommodate loads to a degree not currently possible with other bearing types. In addition, by using a thick pad and engineering the pad to act in partial confinement, the bearing can be made to act as a vertical isolator for dynamic vibration and seismic isolation with a level of flexibility not currently possible with any other structural bearing types. By pre-compressing the pad prior to installation, the bearing can be made to act as a stiff bearing for non-seismic conditions and as a vertical seismic isolation bearing for seismic excitations. These benefits can be achieved with the use of the widely accepted materials of polyurethane and steel (see preferred embodiment), expediting industry acceptance. Furthermore, the bearing of this invention has the additional advantages that
As elastomer “leakage” is not an issue, there are no very small tolerances or clearances in the bearing, they can be fabricated with minimal machining.
Different and potentially easier construction installation techniques may be used, as the bearing design margin is larger and can accommodate much larger rotations (and loads) without duress.
As the bulk of the pad's principle stresses are in compression, the elastomer may be strained to higher levels than possible with other types of elastomeric bearings.
As the bulk of the pad's principle stresses are in compression, the elastomer may be stressed to higher levels than possible with other types of elastomeric bearings.

The stress state produced by partial confinement of the pad in the present bearing invention cannot be reached in a pot bearing because the pot bearing elastomer is in a near hydrostatic stress state. Nor can be this state be reached in a disc or reinforced elastomeric bearing, as no rigid sidewall restraint is provided. No other bearing type can achieve this semi-confined state of stress. The semi-confined bearing of this bearing invention can be designed to accommodate loads, rotations, and vertical displacements not possible with other bearing types.

Although the description above contains many specifications, these should not be construed as limiting the scope of the invention but as merely providing illustrations of some of the preferred embodiments of this invention. For example it is possible to machine a housing from solid steel to take the place of the combined base plate 1 and housing plate 2, or it is possible to make the bearing pad 4 from a fiber reinforced plastic material. Or, it is possible to fill the pad void 13 with a non-structural soft material, thus superficially eliminating the void, but not eliminating the function of the void (room for closure plate rotation and pad expansion). Or the pad 4 and housing 2 can be designed such that phase 1 expansion is time dependent, with phase 2 used to mitigate pad tensile stresses due to creep.

Thus the scope of the invention should be determined by the appended claims and their legal equivalents, rather than by the examples given.

We claim:

1. A structural bearing for transmitting loads from superstructure to substructure, comprising:
(a) a base with housing comprising said structural bearing's bottom and sides, and
(b) a pad loosely fit as means to allow for lateral expansion, and
(c) a top closure plate loosely fit as means to transmit superstructure loads and rotation simultaneously, and
(d) a void with sides comprising said pad, said housing, and said closure plate.

2. The structural bearing of claim 1 wherein said closure plate is means to transmit vertical load to said pad.

3. The structural bearing of claim 1 wherein said closure plate is means to transmit horizontal load to said base.

4. The structural bearing of claim 1 wherein said closure plate is means to transmit structure rotation to said pad.

5. The structural bearing of claim 1 wherein said void is means to ensure partial confinement of said pad.

6. The structural bearing of claim 1 wherein said pad is composed of polyurethane.

7. The structural bearing of claim 1 wherein said pad is sized to be such that the system natural frequency of superstructure load and structural bearing of claim 1 is less than or equal to 10.00 Hz in the vertical direction.

8. The structural bearing of claim 1, wherein means to precompress said pad is provided.

9. The structural bearing of claim 8, wherein said means to precompress said pad is provided by pretensioned bolts anchored into said housing and pulling said closure plate downwards onto said pad.

10. The structural bearing of claim 8, wherein said means to precompress said pad is provided by a preloaded elastomeric pad sandwiched between said closure plate and said housing.

11. A structural bearing with housing and pad for receiving a force applied to said pad's top surface, comprising means to covert said applied force on said pad's top surface to a controllable pressure distribution within the interior of said pad.

12. The pad of claim 11 sized with respect to said housing to allow a portion of said pad sides to expand freely upon compression.

13. The pad of claim 11 sized with respect to said housing such that its sides are in partial contact with the walls of said housing.

14. The pad of claim 11 with surfaces contoured as means to provide partial confinement of said pad.

15. The housing of claim 11 with walls contoured as means to provide confinement of said pad.

16. The pad of claim 11 with surfaces of said pad contoured as means to control stress distribution of said pad.

17. The pad of claim 11 with surfaces of said pad contoured as means to increase rotational capacity.
